(19) United States
(12) Patent Application Publication
(10) Pub. No.: US 2010/0108216 A1
(43) Pub. Date: May 6, 2010

(54) Vehicle Rim for Mounting a Tire

(75) Inventor: Guy Cagneaux, Nohanent (FR)

Correspondence Address: COHEN, PONTANI, LIEBERMAN & PAVANE LLP, 551 FIFTH AVENUE, SUITE 1210, NEW YORK, NY, 10176, US

(73) Assignee: Michelin Recherche et Technique S.A., Granges-Paccot (CH)

(21) Appl. No.: 12/520,855

(22) PCT Filed: Dec. 17, 2007
(86) PCT No.: PCT/EP2007/011046

§ 371 Date: Jan. 4, 2010

Related U.S. Application Data
(60) Provisional application No. 60/900,297, filed on Feb. 8, 2007.

(30) Foreign Application Priority Data
Dec. 22, 2006 (FR) 06/11415

(51) Int. Cl. B60C 15/02

(52) U.S. Cl. 152/381.4

(57) ABSTRACT

A vehicle rim (22-28; 251-252; 262; 272), of revolution, adapted for mounting a tire (30), this rim comprising a first (51; 512) and a second (52; 522) rim seat and a first and a second safety hump (571, 572) which are located axially to the inside of the seats, each of the rim seats being adapted to receive a bead (33) of the tire (30), each of the rim seats having a generatrix the axially inner end of which is on a circle of diameter D_{I} greater than the diameter D_{E} of the circle on which the axially outer end is located, at least one of the seats opening on to a groove (71-78; 791-793) arranged axially between the seat and the safety hump axially closest to the seat.

### FIELD OF THE INVENTION

The present invention relates to a vehicle rim intended for mounting a tire, having what are called inverted seats. It also relates to a tire/wheel assembly fitted with such a rim.

### TECHNOLOGICAL BACKGROUND

Rims having what are called inverted seats are known, for example, from documents U.S. Pat. No. 5,787,950, U.S. Pat. No. 6,415,839, WO 01/08905 and WO 2006/010681; the latter document is considered to be the closest prior art corresponding to the preamble of claim 1.

Tire/wheel assemblies comprising:

a wheel provided with an inverted-seat rim;

a suitable tire, mounted on the rim; and

a bearing support for the tread of the tire

have been marketed under the name “PAX system”, but there are also tire/wheel assemblies having inverted-seat rims and which do not comprise a bearing support.

One difficulty linked to using tire-wheel assemblies provided with inverted-seat rims lies in the fact that the geometry and architecture of the bead of a tire intended to be mounted on an inverted-seat rim impart great stiffness to the bead and consequently cause degradation of the “strike through” performance of the tire. This is understood to mean the transmission of stresses to the body of the vehicle when the tire passes over an obstacle such as a pothole or a kerb.

### DESCRIPTION OF THE INVENTION

The invention is aimed at providing a tire/wheel assembly provided with inverted-seat rims and having improved “strike-through” behavior.

This aim is achieved using a vehicle rim, of revolution, intended for mounting a tire, this rim comprising

a first and a second rim seat;

a first and a second safety hump, located axially to the inside of the seats;

each of the rim seats being intended to receive a bead of the tire, each of the rim seats having a generatrix the axially inner end of which is on a circle of diameter D_{I} greater than the diameter D_{E} of the circle on which the axially outer end is located, at least one of the seats opening on to a groove arranged axially between the seat and the safety hump axially closest to the seat. It should be pointed out that we call a first point “axially internal” to a second point if the first point is closer to the plane perpendicular to the axis of rotation of the tire/wheel assembly (or of the rim) which intersects the rim at mid-width. Conversely, a point is said to be “axially external” to another if it is farther from the plane perpendicular to the axis of rotation of the tire/wheel assembly (or of the rim) which intersects the rim at mid-width.

The definition of what is to be understood precisely by “seat” is given in the description of FIG. 7.

The safety humps may have a geometry such as described, for example, in document WO 2006/010681.

The addition of the said groove allows displacement of the bead of the tire mounted on the rim when the tire is subjected to major deformation, for example when the tire passes over a kerb or a pothole. This displacement enables part of the energy to which the tire is subjected to be absorbed and the force transmitted to the wheel centre and, consequently, to the body of the vehicle on which the tire/wheel assembly is mounted to be reduced.

According to a preferred embodiment, the depth d of the groove (for definition, see FIG. 16) is less than the difference in the diameters D_{I} and D_{E} of the seat which opens on to the groove. This depth is sufficient to permit the displacement mentioned above, while not making the rim fragile.

The groove preferably has a circular or ovoid profile, because such a profile is adapted to the form of the part of the deformed bead which lodges in the groove in the event of a severe impact.

According to another preferred embodiment, the bottom of the groove is flat, which makes manufacture particularly simple. The plane of the bottom of the groove may be perpendicular to the radial direction or alternatively inclined relative to the axial direction, the angle of inclination being between −35° and +55°.

According to one advantageous embodiment, each of the rim seats opens on to a groove arranged axially to the inside of the seat. This makes it possible to obtain the displacement effect mentioned above for each bead of the tire, which is advantageous, insofar as a violent impact may occur on each of the sidewalls of the tire. This embodiment is particularly suited to rims in which the mean diameter of the first rim seat is equal to the mean diameter of the second rim seat (see FIG. 5).

On the other hand, if the mean diameter of the first rim seat is different from the diameter of the second rim seat, it is preferable for at least the rim seat having the greater mean diameter to open on to a groove arranged axially to the inside of the seat. This is because it is on the side of the seat having the larger diameter that the problem of transmission of violent impacts is most acute. It is nevertheless possible, and even preferable, for each of the two seats to open on to a groove arranged axially to the inside of the seat.

The invention also relates to tire/wheel assemblies comprising a vehicle rim according to the invention. According to a preferred embodiment, the tire of the tire/wheel assembly comprises a bead wire and the depth (d) of the groove is at least equal to one third of the diameter D of the bead wire (see FIG. 16). According to another preferred embodiment, the width L of the groove (see FIG. 16) is at least equal to half the diameter D of the bead wire of the tire (30). These two conditions guarantee that the groove is sufficiently deep and wide to accommodate part of the bead in the event of a violent impact.

Preferably, the play S between the bead of the tire and the safety hump (see FIG. 16) is greater than or equal to half the diameter D of the bead wire of the tire, in order to facilitate the movement of the bead as described further above.

The invention relates equally well to tire/wheel assemblies provided with an annular bearing support capable of supporting a tread of the tire in the event of a loss of inflation pressure from the tire and to tire/wheel assemblies which do not comprise such a bearing support.

It should be pointed out that the term “tire” here refers to any type of elastic tires, whether under internal pressure when in use or not.

### BRIEF DESCRIPTION OF THE DRAWINGS

The invention will be better understood thanks to the description of the drawings, in which

FIG. 1 depicts a partial perspective view of a tire/wheel assembly according to the prior art;

FIG. 2 depicts diagrammatically, in meridian section, a tire/wheel assembly according to the prior art;

FIGS. 3 to 5 depict diagrammatically, in partial meridian section, an inverted-seat rim with or without a bearing support;

FIG. 6 depicts the force transmitted to the suspension in the event of a violent impact as a function of the diameter of the rim, at a constant diameter of the tire/wheel assembly, for conventional rims and an inverted-seat rim;

FIGS. 7(a) and (b) illustrate the exact extent of the seat for complex rim geometries;

FIGS. 8(a) and (b) depict the contact pressures between the bead of the tire and an inverted-seat rim as a function of the position on the seat;

FIGS. 9(a) and (b) depict two rim seats according to the invention;

FIGS. 10(a) and (b) depict diagrammatically the positioning of a tire bead on a rim according to the invention, in normal operation (a) and upon an impact with a kerb (b);

FIGS. 11 to 13 depict rims according to the invention;

FIGS. 14 and 15 depict rim seats according to the invention;

FIG. 16 illustrates parameters for characterizing a tire/wheel assembly according to the invention;

FIG. 17 depicts the force exerted at the centre of the wheel as a function of the loading of the tire (on a Zwick machine) on flat ground;

FIG. 18 depicts the force exerted at the centre of the wheel as a function of the loading of the tire (on a Zwick machine) on a corner.

### DETAILED DESCRIPTION OF THE DRAWINGS

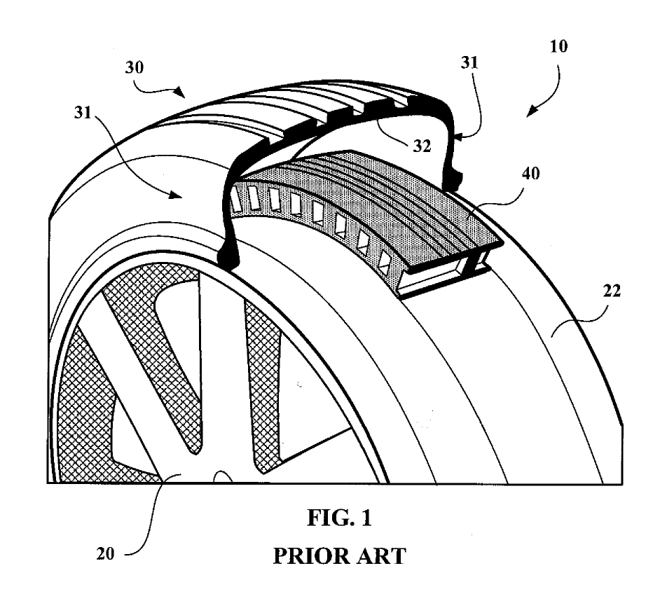

FIG. 1 depicts diagrammatically in perspective view a partial section of a tire/wheel assembly 10 of “PAX system” type comprising a wheel 20 with its inverted-seat rim 22, a tire 30 provided with sidewalls 31 and a crown 32, and a bearing support 40. When the tire deflates, for example following a puncture, the weight of the vehicle causes the sidewalls 31 to flex such that, in the proximity of the contact zone between the tire 30 and the roadway, the crown 32 comes into contact with the bearing ring 40. The “PAX system” is shown as the most common use of an inverted-seat rim, hut, as has been stated further above, rims of the inverted-seat type are in no way limited to such a use. There are in fact tire/wheel assemblies without bearing support, and the invention also relates to these assemblies.

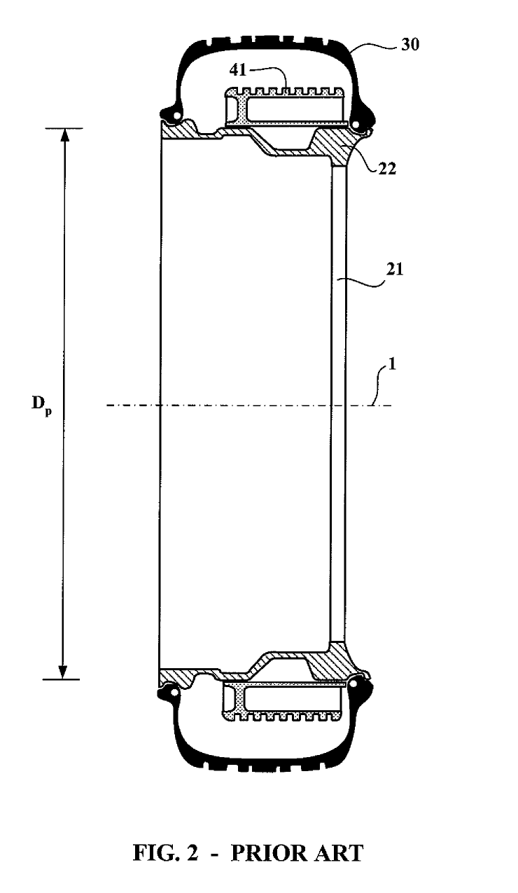

FIG. 2 depicts diagrammatically, in meridian section, a tire/wheel assembly of “AX system” type comprising a wheel (formed of a rim 22 and a disc 21), a tire 30 and a bearing support 41. The axis of rotation 1 of the tire/wheel assembly is also indicated.

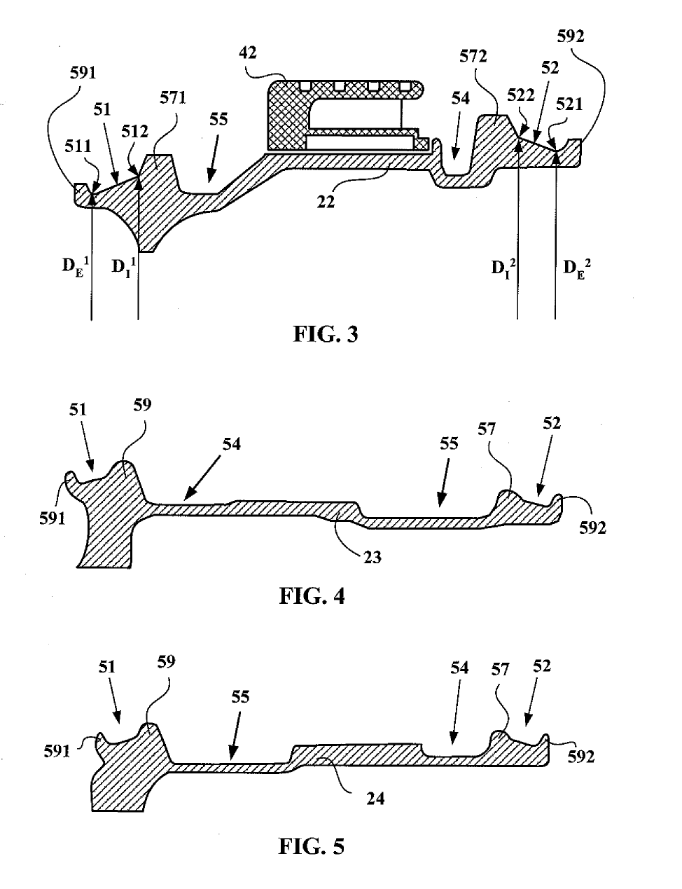

FIG. 3 depicts diagrammatically, in partial meridian section, a rim 22 and a bearing support 42 for a tire/wheel assembly of “PAX system” type. For the sake of clarity, the tire 30 is not shown. The rim 22 comprises two rim seats 51 and 52 of different mean diameters. Each of the rim seats 51 and 52 is intended to receive a bead of the tire. The generatrix of the rim seat 51 has an axially inner end 512 which is located on a circle of diameter D_{I}¹, D_{I}¹ being greater than the diameter D_{E}¹ of the circle on which the axially outer end 511 is located; thus the rim seat 51 is an “inverted seat”. Likewise, the generatrix of the rim seat 52 has an axially inner end 522 which is located on a circle of diameter D_{I}², D_{I}² being greater than the diameter D_{E}² of the circle on which the axially outer end 521 is located. The seats 51 and 52 are delimited axially to the outside by rim hooks 591, 592 and axially to the inside by safety humps 571 (here in the form of what is sometimes called a “ledge”, suitable for mounting the bearing support 42) and 572.

The rim 22 also comprises a mounting groove 54 intended to permit mounting of the tire and a weight reduction groove 55 intended to reduce the weight of the rim.

FIG. 4 represents diagrammatically, in partial meridian section, another inverted-seat rim 23. Unlike the rim 22, the mean diameter of the seat 51 close to the wheel disc 21 (FIG. 2) is greater than the mean diameter of the seat 52. Axially to the inside of each of the seats there is a safety hump 571, 572.

FIG. 5 represents diagrammatically, in partial meridian section, a third inverted-seat rim 24. This rim is distinguished from the rims of FIGS. 3 to 4 in that the mean diameter of the two seats 51 and 52 is identical.

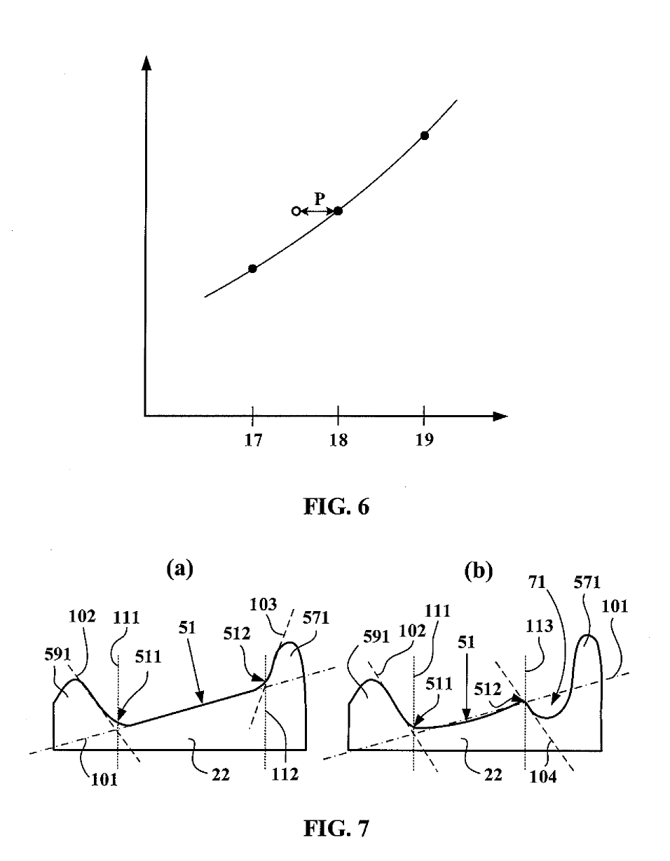

FIG. 6 illustrates one difficulty observed when using inverted-seat rims compared with traditional rims (that is to say ones having non-inverted seats). The graph shows the force transmitted to the suspension in the event of a violent impact, as a function of the diameter of the rim, at a constant tire-wheel assembly diameter. The values corresponding to three different rim diameters (17, 18 and 19 inches) exhibit, for traditional rims (solid circles), an increase in the force transmitted as a function of the diameter: the greater the diameter of the rim (at constant tire-wheel assembly diameter (also known by the name “overall” diameter)!), the lesser the height of the sidewall of the tire and the less the tire is capable of absorbing the impacts to which it is subjected. The value obtained with an inverted-seat rim (empty circle) shows that the force transmitted by a tire/wheel assembly fitted with such rims is greater than the force which would be transmitted by a tire/wheel assembly fitted with a traditional rim of the same diameter. The difference can be assessed by considering the difference in diameter P between a traditional rim and a rim with inverted seats which transmit the same force to the wheel centre when they are stressed in the same manner. Typically, P lies between 0.5 and 1.2 inches.

FIG. 7 illustrates the precise extent of the seat for geometries where the transition between the seat and the elements surrounding it is not totally unequivocal. The person skilled in the art will understand “seat” to be that part of the rim which is intended to come into contact with the bead of the tire, permanently. Not considered as forming part of the seat is the rim hook, which comes into contact with the bead of the tire when the latter is stopped but which can lose contact with the bead when the tire is under great stress.

FIG. 7(a) shows a seat 51 of a traditional inverted-seat rim 22. The transition between the seat 51 and the rim hook 591 and the transition between the seat 51 and the safety hump 571 is rounded, which makes it difficult to ascertain the precise extent of the seat, all the more so if the latter is not flat, as is the case with the seat 51 of FIG. 7(b). The procedure for determining the axially outer end 511 of the seat is as follows: the mean tangent 101 to the central part of the seat and its intersection with the tangent 102 to the wall of the part of the rim hook 591 on to which the seat opens are determined. The end 511 of the seat then corresponds to the intersection of the radial direction 111, which passes through the point of intersection between the tangents 101 and 111, with the surface of the rim. Analogously, the end 512 of the seat 51 is determined, by replacing the tangent 102 to the wall of that part of the rim hook 591 on to which the seat opens, with the tangent 103 to the wall of the safety hump 571 on to which the seat opens. The end 512 of the seat then corresponds to the intersection of the radial direction 112, which passes through the point of intersection between the tangents 101 and 103, with the surface of the rim.

The procedure is analogous for the rims according to the invention which comprise a groove 71. In this case in point, the tangent 104 to the wall of the groove on to which the seat opens is determined and its intersection with the mean tangent 101 is determined. The end 512 of the seat corresponds to the intersection of the radial direction 113, which passes through the point of intersection between the tangents 101 and 104, with the surface of the rim.

FIG. 8 shows the contact pressures between the bead 33 of the tire 30 and an inverted-seat rim 25 as a function of the axial position on the seat. FIG. 8(b) shows the bead 33 of the tire and the seat 51 of the rim 25. The bead wire 34 and the anchoring of the carcass ply 35 around the bead wire are also shown. FIG. 8(b) shows the contact pressures calculated between the bead 33 and the rim 25 over the width of the seat 51, at two inflation pressures (high pressure: unbroken line, low pressure: broken line). The maximum pressure is observed in the zone of contact with the hook 56 of the rim 25. When moving axially away from the hook, towards the bead wire 34, the pressure drops, reaching a new peak in the zone compressed by the bead wire 34. Beyond the line 60, the contact pressure rapidly drops to zero.

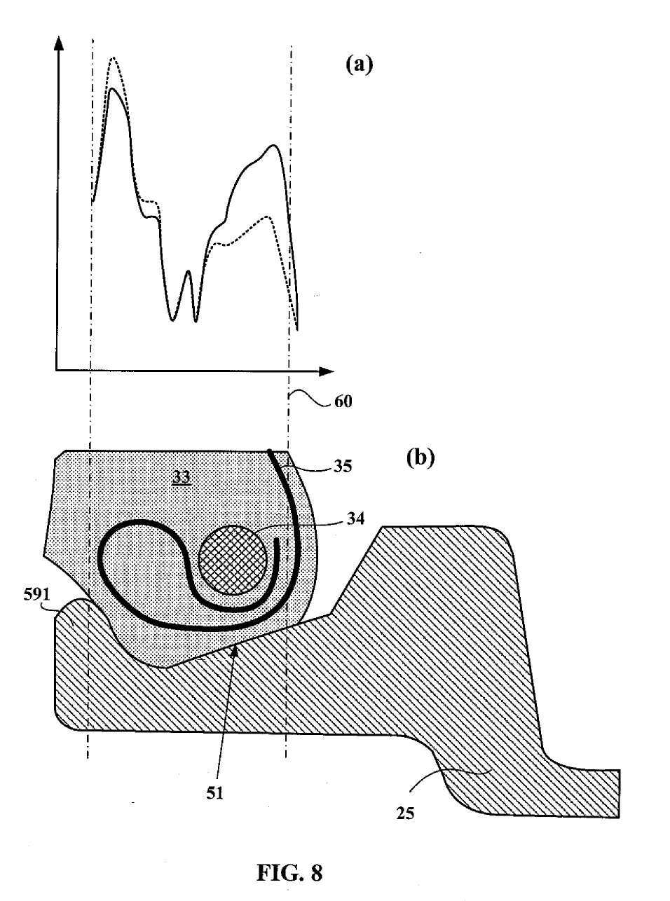

The invention departs from the observation that the contact pressure is not applied over the entire width of the seat, but that the part axially inwards of the line 60 does not contribute to establishing airtight contact between the bead 33 and the rim 25. This surprising observation (given the positioning of the carcass ply) is exploited in a rim according to the invention by the provision of a groove, as shown in FIG. 9.

FIGS. 9(a) and (b) depict rim ends according to the invention. FIG. 9(a) shows one end of a rim 26 which corresponds to the end of the rim 22 (see FIG. 3) which comprises the seat 52. Relative to the latter, the seat is shortened and opens axially to the inside on to a groove 71. This groove is delimited by a safety hump 57 which is narrower than the corresponding safety hump of the rim 22. The geometry of the rim 22 is suggested by broken lines, in order to facilitate comparison.

FIG. 9(b) corresponds to the application of the same measures to the end of the rim 23 (see FIG. 4) which comprises the seat 51. Again, the rim according to the invention is distinguished by the addition of a groove 72; the seat proper is shortened and the safety hump on to which the seat opens is made narrower. Again, the geometry of the rim 23 is suggested in broken lines, in order to permit easy comparison.

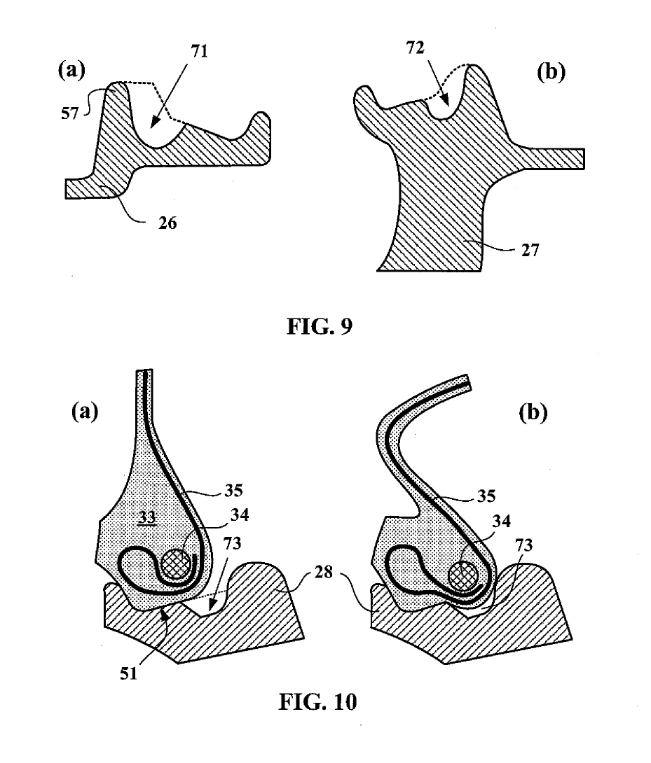

Providing such a groove 71 or 72 makes it possible to solve the technical problem posed, for reasons which are illustrated in FIG. 10. FIG. 10(a) shows the “normal” configuration, that is to say when the tire/wheel assembly is stopped or travelling on flat ground: the bead 33 of the tire 30 is lodged on the seat 51 of the rim 28 according to the invention, provided with a groove 73. The bead wire 34 and the end of the carcass ply 35 are also shown.

FIG. 10(b) depicts a situation in which the tire/wheel assembly is subjected to a violent impact, for example when the tire passes over a large-sized obstacle, such as a kerb. In such a situation, the groove 73 enables the bead wire to be displaced, at least partially filling the groove. Thus it is possible to absorb part of the deformation of the tire 30 and to prevent the impact from being integrally transmitted to the vehicle. When the stress ends, the movement is reversed and the configuration of FIG. 10(a) is regained.

When the two seats of the rim are not at the same radial height, as is often the case for inverted-seat rims, it is advisable to provide the groove at least on the seat which has the larger mean diameter. It is nevertheless possible, and even preferable, to provide such grooves for both seats.

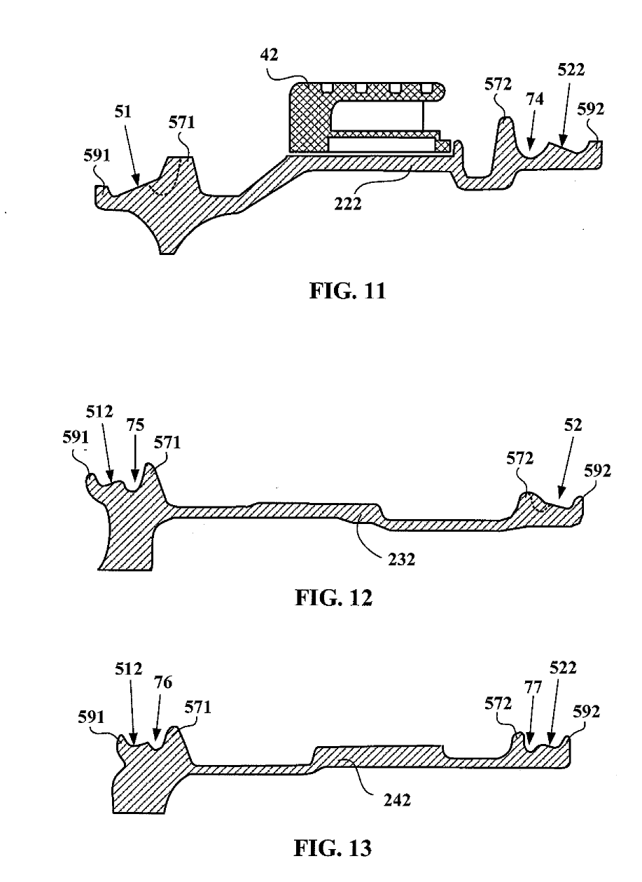

FIGS. 11 to 13 correspond to FIGS. 3 to 5, the rims having been modified according to the invention. The rim 222 is provided with a groove 74 on to which opens the seat 522, which has a larger mean diameter than the seat 51. The latter could also have been provided with a groove, as is suggested in broken lines. The rim 232 of FIG. 12 corresponds to that of FIG. 4, but here the seat 512 of greater radial diameter opens on to a groove 75. Again, it would have been possible also to provide the second seat 52 with such a groove. FIG. 13 depicts the case of an inverted-seat rim 242, the mean diameters of which are identical. In this case, it is preferable to provide grooves 76 and 77 at the end of both seats 51 and 52.

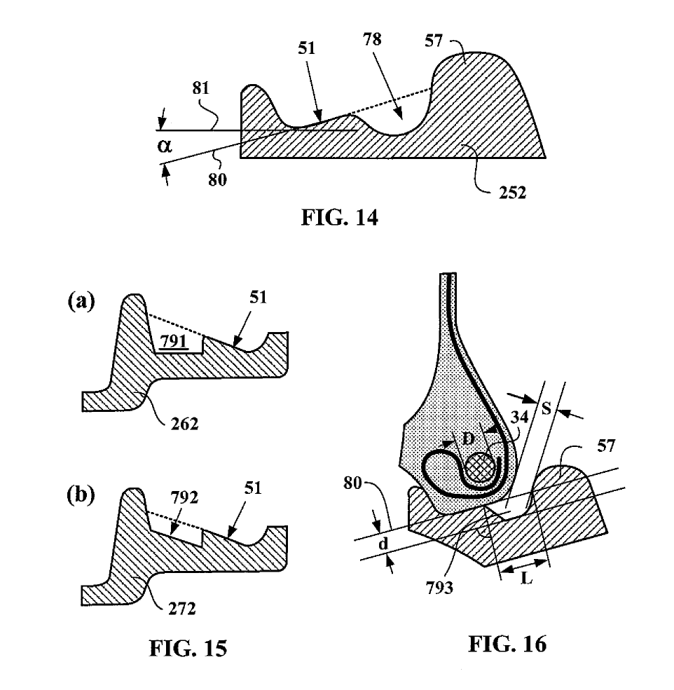

FIG. 14 represents diagrammatically an inverted seat 51 of a rim 252 according to the invention. This seat 51 has an inclination alpha (α) which is defined as the angle, in a radial section plane, between the tangent 80 to the central part of the seat and a direction parallel to the axis of rotation 81 of the rim. In this case, the angle alpha (α) is 15°. “Radial” is understood here to mean a direction perpendicular to the axis of rotation of the tire/wheel assembly (which is identical to the axis of rotation of the rim) and which intersects this axis. A radial plane is a plane comprising the axis of rotation.

The groove 78 on to which the seat 51 opens corresponds to the space between the rim and the prolongation of the tangent 80 towards the safety hump 57. In this case, this groove is rounded, but this is only one embodiment among others. FIG. 15 shows ends of other rims 262 and 272 according to the invention where the groove has a flat bottom, which may be inclined (FIG. 15(b)) or not (FIG. 15(a)) relative to the axial direction. If the bottom is flat and inclined, its inclination may or may not be identical to the inclination of the seat; preferably, the angle of inclination thereof lies between −35° (the negative sign indicates an inclination opposed to that of the seat) and +55°. An ovoid geometry corresponds to another preferred embodiment.

FIG. 16 illustrates parameters for characterizing a tire/wheel assembly according to the invention. The depth “d” of the groove 793 is defined as the maximum distance between the prolongation of the tangent 80 to the seat and the bottom of the groove.

The width “L” of the groove 793 corresponds to the distance between the axially inner end of the seat and the point of intersection between the tangent 80 to the seat and the safety hump 57.

Finally, the play “S” between the bead 33 of the tire 30 and the safety hump 57 is defined as the minimum distance between a point of the bead 33 and a point of the safety hump 57 when the tire/wheel assembly is stopped and not loaded.

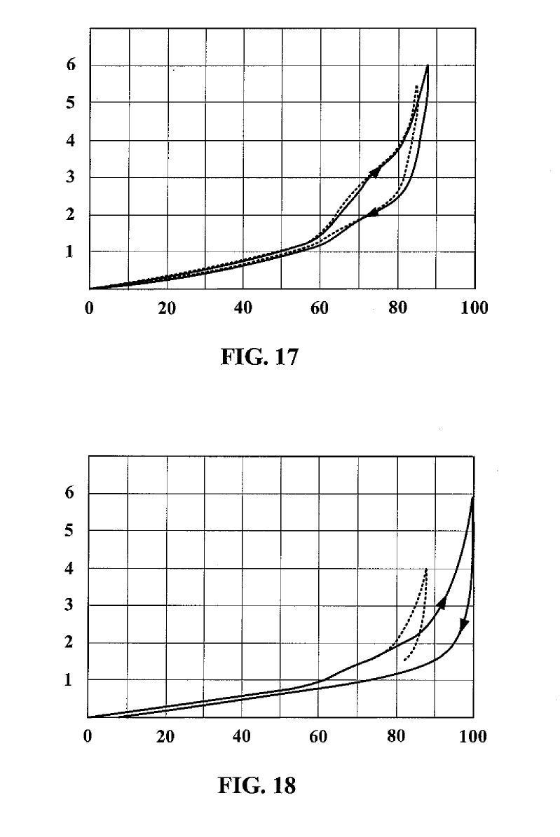

FIGS. 17 and 18 represent results obtained with tire/wheel assemblies according to the invention. FIG. 17 depicts the force exerted at the centre of the wheel as a function of the loading of the tire (on a Zwick machine) on flat ground. A tire/wheel assembly of the “PAX system” type (broken-line curve) is compared with an assembly according to the invention (unbroken line). When loaded on flat ground, a slight “delay” is noted for the assembly according to the invention, which conveys the fact that the assembly according to the invention has to be deflected by several additional millimeters in order to transmit as much force to the wheel centre.

The effect is far more pronounced when the loading is on a corner, as shown in FIG. 18: the lag or “delay” here corresponds to about ten millimeters. When equally loaded, the tire/wheel assembly according to the invention thus transmits distinctly less force to the wheel centre than the reference assembly.

This improvement was also demonstrated in a test of “pothole” type, known to the person skilled in the art. This test makes it possible to determine the forces at the wheel centre in the event of a severe impact. The results were obtained with a PAX 235-660R480U tire on a BMW series 7 vehicle, for a travelling speed of close to 50 km/h and a pothole of a depth of approximately 70 mm. The results are summarized in Table 1:

TABLE 1
Results obtained in a test of “pothole” type

| Force transmitted to the | “PAX system” | Assembly according |
|---|---|---|
| chassis [kN] | (reference system) | to the invention |
| Fx | 27 | 22 |
| Fz | 53 | 42 |
| Fxz = (Fx² + Fy²)^{1/2} | 60 | 47 |

Fx designates the force transmitted in the direction of displacement of the vehicle, and Fz the force transmitted in the vertical direction.

It will be noted that the modification of the rim reduces the forces at the wheel centre by approximately 20% in the event of a severe impact.

It should also be noted that the invention has no adverse impact on the ease of mounting or demounting the tire.

1. A vehicle rim, of revolution, adapted for mounting a tire, this rim comprising:
a first and a second rim seat; and
a first and a second safety hump located axially to the inside of the seats;
each of the rim seats being adapted to receive a bead of the tire, each of the rim seats having a generatrix the axially inner end of which is on a circle of diameter D_{I} greater than the diameter D_{E} of the circle on which the axially outer end is located, wherein at least one of the seats opens on to a groove arranged axially between the seat and the safety hump closest to the seat.

2. The vehicle rim according to claim 1, wherein the depth of the groove is less than the difference in the diameters D_{I} and D_{E} of the seat which opens on to the groove.

3. The vehicle rim according to claim 1, wherein the groove has, in a radial section, a circular or ovoid profile.

4. The vehicle rim according to claim 1, wherein the bottom of the groove is flat.

5. The vehicle rim according to claim 4, wherein the bottom of the groove is inclined relative to the axial direction, the angle of inclination being between −35° and +55°.

6. The vehicle rim according to claim 1, wherein each of the seats opens on to a groove arranged axially to the inside of the seat.

7. The vehicle rim according to claim 1, wherein the mean diameter of the first rim seat is equal to the mean diameter of the second rim seat.

8. The vehicle rim according to claim 1, wherein the mean diameter of the first rim seat is different from the mean diameter of the second rim seat.

9. The vehicle rim according to claim 8, wherein at least the rim seat having the greater mean diameter opens on to a groove arranged axially to the inside of the seat.

10. A tire/wheel assembly comprising a vehicle rim according to claim 1.

11. The tire/wheel assembly according to claim 10, wherein the tire comprises a bead wire and in which the depth of the groove is at least equal to one third of the diameter of the bead wire of the tire.

12. The tire/wheel assembly according to claim 10, wherein the tire comprises a bead wire and in which the width of the groove is at least equal to half the diameter of the bead wire of the tire.

13. The tire/wheel assembly according to claim 10, wherein the tire comprises a bead wire and in which the play between the bead of the tire and the safety hump is greater than or equal to half the diameter of the bead wire of the tire.

14. The tire/wheel assembly according to claim 10, wherein the assembly is furthermore provided with an annular bearing support capable of supporting a tread of the tire in the event of a loss of inflation pressure from the tire.
